(19) United States
(12) Patent Application Publication
(10) Pub. No.: US 2013/0345977 A1
(43) Pub. Date: Dec. 26, 2013

(54) MAP UPDATING SYSTEM

(71) Applicant: DENSO CORPORATION, Kariya-city (JP)

(72) Inventors: Yasuhiro SHIMIZU, Tokoname-city (JP); Nobuhiro MIZUNO, Ichihara-city (JP)

(73) Assignee: DENSO CORPORATION, Kariya-city (JP)

(21) Appl. No.: 13/904,068

(22) Filed: May 29, 2013

(30) Foreign Application Priority Data
Jun. 26, 2012 (JP) 2012-143337

(51) Int. Cl. G01C 21/34

(52) U.S. Cl. CPC G01C 21/34
USPC 701/533

(57) ABSTRACT

A map updating system, which includes a navigation apparatus in a vehicle and a map server, includes a driving history database storage storing driving history data on the vehicle. The map updating system determines, based on the driving history data, a location visited a predetermined number of times or more as a first destination; determines, based on the driving history data, a route which was used a predetermined number of times or more among routes used to visit the first destination as a first route; determines a second route that is to be used to visit the first destination when a part of the first route is unusable; and updates map data in the navigation apparatus in order of (i) data on the first route and second route and (ii) other data.

### CROSS REFERENCE TO RELATED APPLICATION

The present application is based on Japanese Patent Application No. 2012-143337 filed on Jun. 26, 2012, the disclosure of which is incorporated herein by reference.

### TECHNICAL FIELD

The present disclosure relates to a map updating system of updating map data in a navigation apparatus.

### BACKGROUND ART

Patent literature 1: JP 2004-257902 A
Patent literature 2: JP 2007-114100 A
Patent literature 3: JP 2003-65772 A

There have been systems for distributing map data to navigation apparatuses. There is demand that, in cases where map data is downloaded to a navigation apparatus via a network, the volume of data to be downloaded be small with the data communication speed and capacity for data update processing taken into consideration. In the map updating systems described in Patent literatures 1 to 3, map data is partially downloaded to a navigation apparatus.

In Patent literature 1, a navigation apparatus to be mounted on a vehicle is disclosed in which map data update information is periodically downloaded and stored so as to effectively save communication operation and cost. In the navigation apparatus, when displaying the map data downloaded and stored in the navigation apparatus, a determination/updating section determines, based on the stored map data update information, whether or not the map data has been updated. When it is determined that the map data has been updated, the updated map data is downloaded from the server and is stored in a map storage area.

In Patent literature 2, a map information distribution system is disclosed in which users requiring updated map information can have the updated map information distributed to them on a priority basis so as to enable such users to quickly obtain the updated map information and so as to prevent congestion of communications between vehicle-mounted navigation terminals and the map information distribution center. In the map information distribution system, when the map information stored in a vehicle-mounted navigation terminal includes a portion not reflecting the latest update, the degree of necessity to update such a portion of map information is determined based on the number of times the portion of map information was used. When, as a result, the degree of necessity to update the portion of map information is determined to be high, the corresponding updated map information is distributed to the vehicle-mounted navigation terminal.

In Patent literature 3, a communication navigation terminal is disclosed which does not require map data to be re-acquired even when the vehicle mounted with the terminal moves out of a usual driving range. In the communication navigation terminal, the map data on a user's driving range is statistically analyzed based on movement locus information and, based on the results of the analysis, the map data on an initial driving range of the user is dynamically changed.

A navigation apparatus provides route guidance based on a map. Where the map does not agree with real roads, the navigation apparatus cannot provide appropriate route guidance and the user may get lost. For example, when a route usually used by the user is closed to traffic forcing the user to use an alternative route, the navigation apparatus may not be able to appropriately guide the user through the alternative route unless the map is up to date. In a case where an expressway usually used by the user is partly closed, the user cannot but use an alternative open road for the closed section of the expressway. The user accustomed to the expressway, however, may not have ever got off the expressway partway and may be familiar with no alternative open roads. In such a case, it is quite important to respond to user's demand that the navigation apparatus correctly guide the user through an alternative route. In the existing map updating systems described above, the map portions or areas to be updated are determined based on driving history data, so that they cannot respond to the user's demand suitably.

### SUMMARY

An object of the present disclosure is to provide a map updating system which enables users requiring road information to obtain the required road information on a priority basis.

To achieve the above object, according to an aspect of the present disclosure, a map updating system is provided with a map server having latest map data and a navigation apparatus coupled to the map server via a network. In the map updating system, map data held by the navigation apparatus is updated with the latest map data stored in the map server. The map updating system is provided with: a driving history database storage storing driving history data on the vehicle mounted with the navigation apparatus; a first destination determining section which determines a first destination based on the driving history data, the first destination being a location visited from a predetermined location a predetermined number of times or more or at a predetermined frequency or more; a first route searching section which determines a first route based on the driving history data, the first route being a route that was used a predetermined number of times or more or at a predetermined frequency or more among routes having been used to visit the first destination from the predetermined location; a second route searching section which determines a second route that is to be used to visit the first destination from the predetermined location when a part of the first route is unusable; and a map updating section which updates the map data in the navigation apparatus in an order of (i) data on the first route and the second route, and (ii) other data.

The first route leading to the first destination frequently visited by the user is a route usually used by the user. The second route to be used when a part of the first route cannot be used is a route which is selected by the user when the route usually used cannot be used. Thus, according to the above aspect, the first route and the second route are updated on a priority basis. In this way, the map portions required by the user can be efficiently updated based on the route usually used by the user.

According to another aspect of the present disclosure, a method for a map updating system is provided as follows. The map updating system includes a map server and a navigation apparatus coupled to the map server via a network. The navigation apparatus contains map data that is updated with latest map data in the map server. The method includes: storing driving history data on the vehicle mounted with the navigation apparatus; determining a first destination based on the driving history data, the first destination being a location visited from a predetermined location a predetermined number of times or more or at a predetermined frequency or more; determining a first route based on the driving history data, the first route being a route that was used a predetermined number of times or more or at a predetermined frequency or more among routes having been used to visit the first destination from the predetermined location; determining a second route that is to be used to visit the first destination from the predetermined location when a part of the first route is unusable; and updating the map data in the navigation apparatus in an order of (i) data on the first route and the second route, and (ii) other data.

As yet another aspect of the present disclosure, a program product stored in a non-transitory computer readable medium comprising instructions being executed by a computer is provided, wherein the instructions includes the above method for the map updating system and the method is computer-implemented.

### BRIEF DESCRIPTION OF THE DRAWINGS

The above and other objects, features, and advantages of the present disclosure will become more apparent from the following detailed description made with reference to the accompanying drawings as follows.

FIG. 1 is a diagram showing the configuration of a map updating system according to a first embodiment of the present disclosure.

FIG. 2 is a diagram for describing route searching performed by a route searching section.

FIG. 3 is a diagram showing the configuration of a navigation apparatus according to the first embodiment.

FIG. 4 is a diagram showing example data stored in a driving history database storage.

FIG. 5 is a flowchart showing operation of the map updating system according to the first embodiment.

FIG. 6 is a flowchart showing the operation of map data transmission performed in the map updating system according to the first embodiment.

FIG. 7 is a diagram showing the configuration of a navigation apparatus according to a second embodiment of the present disclosure.

FIG. 8 is a flowchart showing operation of a map updating system according to the second embodiment.

FIG. 9 is a flowchart showing the operation of map data transmission performed in the map updating system according to the second embodiment.

FIG. 10 is a diagram showing the configuration of a navigation apparatus according to a third embodiment of the present disclosure.

FIG. 11 is a diagram showing relationships between a first route and first areas and between a second route and a second area.

FIG. 12 is a flowchart showing operation of a map updating system according to the third embodiment.

FIG. 13 is a flowchart showing the operation of map data transmission performed in the map updating system according to the third embodiment.

FIG. 14 is a diagram showing examples of first and second areas determined in a map updating system according to a fourth embodiment of the present disclosure.

FIG. 15 is a diagram showing the configuration of a navigation apparatus according to a fifth embodiment of the present disclosure.

FIG. 16 is a flowchart showing operation of a map updating system according to the fifth embodiment.

FIG. 17 is a flowchart showing the operation of map data transmission performed in the map updating system according to the fifth embodiment.

FIG. 18 is a diagram showing the configuration of a navigation apparatus according to a sixth embodiment of the present disclosure.

FIG. 19 is a flowchart showing operation of a map updating system according to the sixth embodiment.

FIG. 20 is a flowchart showing the operation of map data transmission performed in the map updating system according to the sixth embodiment.

### DETAILED DESCRIPTION

A map updating system according to embodiments of the present disclosure will be described below with reference to drawings.

### First Embodiment

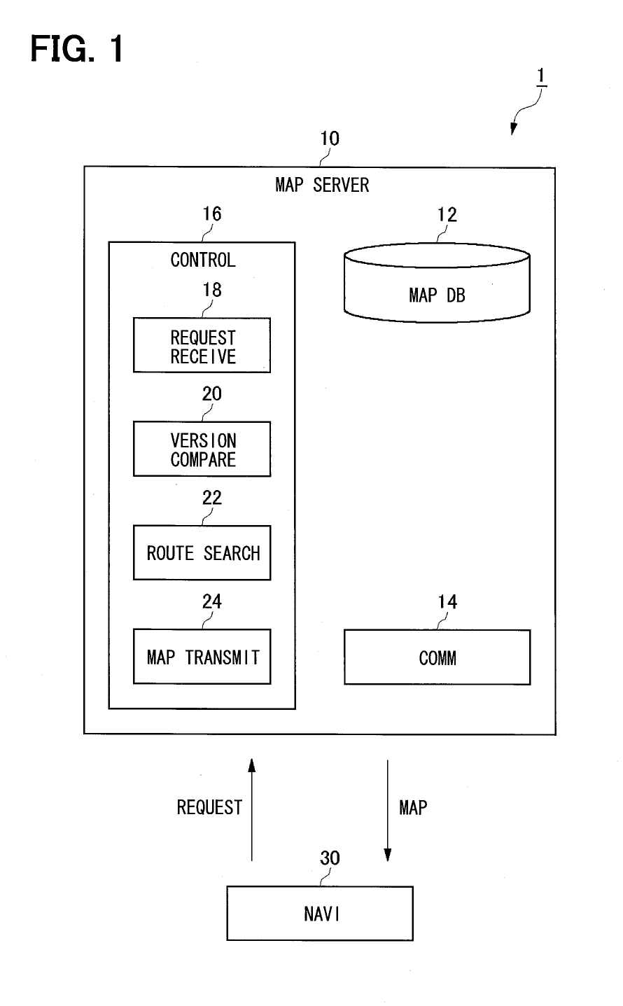

FIG. 1 shows the configuration of a map updating system 1 according to a first embodiment of the present disclosure. The map updating system 1 includes a map server 10 storing latest map data and a navigation apparatus 30 to be vehicle-mounted for use. The “latest map data” does not refer to the map data that reflects the latest condition of every existing road, but it refers to map data which has sequentially been updated to reflect conditions of existing roads. The map server 10 and the navigation apparatus 30 are coupled with each other via a network. The navigation apparatus 30 transmits a map update request to the map server 10. Responding to the map update request, the map server 10 transmits the latest map data to the navigation apparatus 30, which permits the map data held by the navigation apparatus 30 to be updated.

The map server 10 includes a map database storage (hereinafter referred to as the “map DB storage”) 12, a communication portion 14 for communication with the navigation apparatus 30, and a control circuit 16 for controlling map updating. The map DB storage 12 stores map data as data on road links making up a map. The map DB storage 12 also stores earlier-version map data in addition to the latest-version map data. Therefore, when, for example, the shape of a road is changed, correspondence between the latest-version road link IDs and earlier-version road link IDs associated with the road can be grasped. Therefore, when, as a result of changes made in the shape of a road or in related road connections, any earlier-version road link ID is put out of use, the latest-version road link ID corresponding to the earlier-version road link ID can be determined so as to allow the relevant map data to be updated to the latest version.

The control circuit 16 includes a map update request receiving section 18, a version comparing section 20, a route searching section 22, and a map data transmitting section 24. The map update request receiving section 18 receives a map update request transmitted from the navigation apparatus 30. A map update request includes, as being described in detail later, (i) data on a route (a first route) to a destination (a first destination) frequently visited by the user, (ii) version information about the map data on the road links forming the first route, and (iii) data on another route to the first destination previously used by the user (hereinafter referred to as a “used route”).

The version comparing section 20 compares, concerning the road links forming the first route, (i) the version information about the map data held by the navigation apparatus 30 and (ii) the version information about the map data held by the map server 10. When, as a result, the version information is found identical between the former and the latter map data, the former map data held by the navigation apparatus 30 is determined to be the latest one. In this case, the map data on the road links forming the first route need not be updated.

The route searching section 22 can determine, by route searching, a route (a second route) to the first destination which can be used in cases where a part of the first route to the first destination cannot be used. In such cases, the route searching section 22 searches for a route leading from a starting location to the first destination. When a route found in such cases differs from the first route, the route searching section 22 determines the route as a second route. The route search may be performed specifying two locations along the first route as a starting location and a destination.

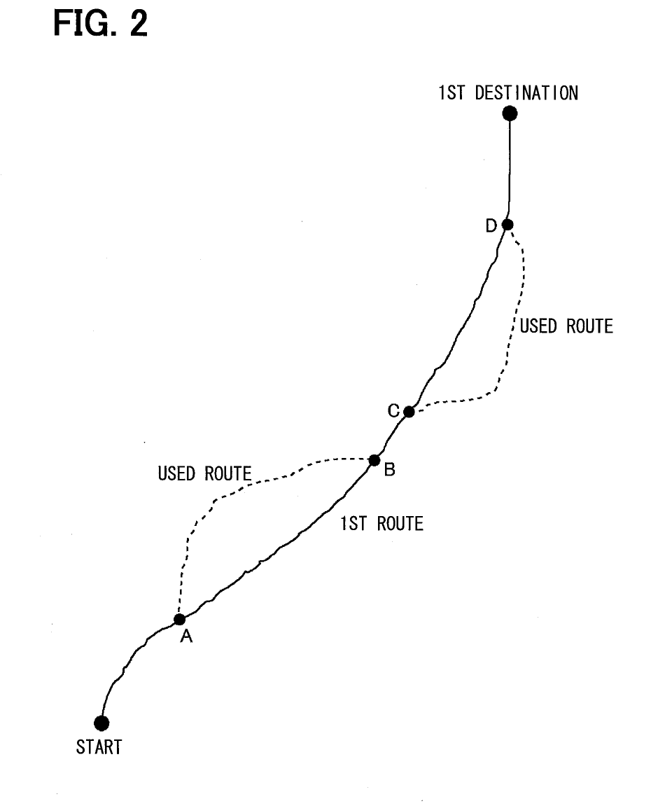

FIG. 2 is for describing route searching performed by the route searching section 22. The map server 10 receives, from the navigation apparatus 30, along with data on the first route, data on another route used to go to the first destination. In FIG. 2, the two routes each denoted as “USED ROUTE” represent routes which were previously used by the user to go to the first destination. Neither of them was determined as the first route because the numbers of times they were used respectively were smaller than a predetermined number.

In searching for a route, the route searching section 22 may specify a location where a used route branches from the first route as a starting location and a location where the used route rejoins the first route as a destination. Namely, referring to FIG. 2, points A and B or, alternatively, points C and D may be specified as a starting location and a destination, respectively. This makes it possible to determine an alternative route (a second route) in cases where the portion between points A and B or between points C and D of the first route cannot be used. According to the present embodiment, route searching is performed by the map server 10, so that an appropriate second route can be determined even in cases where the used routes are no longer represented on the latest-version map.

The map data transmitting section 24 transmits map data to the navigation apparatus 30. When map data on a first route and a second route is to be transmitted, the map data transmitting section 24 transmits map data on the first route, map data on the second route, and other map data in this order.

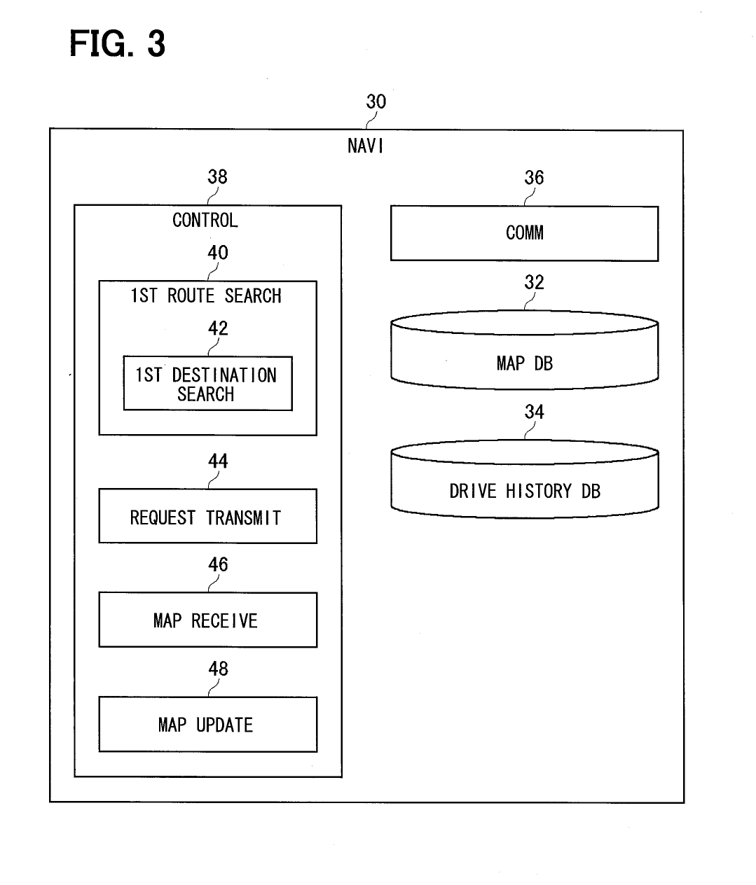

FIG. 3 shows the configuration of the navigation apparatus 30. The navigation apparatus 30 includes a map database storage (hereinafter referred to as the “map DB storage”) 32 storing map data, a driving history database storage (hereinafter referred to as the “driving history DB storage”) 34 storing vehicle's driving history data, a communication portion 36 for communication with the map server 10, and a control circuit 38 for updating map data. The navigation apparatus 30 updates the data stored in the map DB storage 32 either periodically or as needed. Though not shown in FIG. 3, the navigation apparatus 30 includes a route searching function, a route guiding function, an input portion for inputting information, and an output section for outputting information. The navigation apparatus 30 is coupled to a current location detecting portion for detecting the vehicle's current location.

The map DB storage 32, like the map DB storage 12 held by the map server 10, stores map data prepared as data on the road links making up the map. The map DB storage 32 also stores version information indicating the version on which the data on each road link is based. When the whole map has been updated, all road links are associated with the same version information. When the map is halfway in the process of being entirely updated, the version information can differ between road links. Road link data on areas not usually referred to by the user causes no problem even if the data is based on old versions. Hence, there may be cases in which road link data based on different versions is mixedly stored.

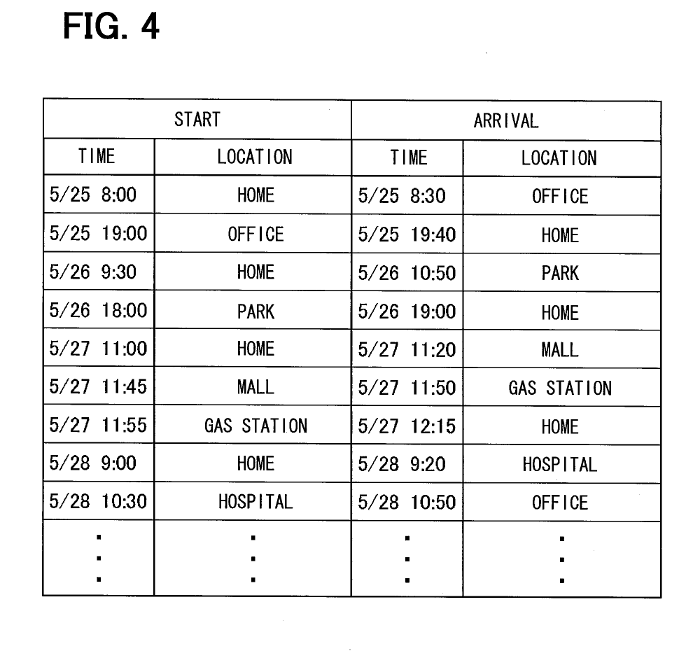

FIG. 4 shows example data stored in the driving history DB storage 34. As shown, the driving history DB storage 34 stores such data as starting date/time, starting location, arrival date/time, and arrival location. The navigation apparatus 30 updates the driving history data based on the data representing the vehicle's current location detected by the current location detecting portion.

The starting date/time and the starting location represent the time and location data obtained when the vehicle engine is started. The arrival date/time and the destination represent the time and location data obtained when the vehicle engine was switched off. These data can be stored in the driving history DB storage 34 by obtaining (i) the time data representing when the ignition key was turned on/off and (ii) the location data detected by the current location detecting portion when the ignition key was switched on/off.

The names entered as starting locations and arrival locations represent facilities determined, based on the map DB storage 32, as corresponding to the starting locations and arrival locations and read out from the map DB storage 32. The data shown in FIG. 4 only represent example driving history data. Namely, the driving history DB storage 34 may hold driving history data in a different format. For example, the location data detected by the current location detecting portion may be held as time-series data.

The control circuit 38 includes a first route searching section 40, a map update request transmitting section 44, a map data receiving section 46, and a map updating section 48. The first route searching section 40 includes a first destination searching section 42. The first destination searching section 42 finds, based on the data stored in the driving history DB storage 34, a location (a first destination) visited a predetermined number of times (e.g. 15 times) or more within a predetermined period of time (e.g. the last three months). The first route searching section 40 then searches for the most used one of the routes used to go to the first destination and determines the most used route as a first route. Instead of the route most used to go to the first destination, the first route searching section 40 may determine a route used a predetermined number of times (e.g. five times) or more to go to the first destination as a first route. The first route thus determined is a route frequently used by the user. Such a route is updated on a priority basis when a corresponding part of the map is changed.

While searching for a first route, the first route searching section 40 also searches for another route (a used route) used to go to the first destination. Such a route is one not so frequently used as the first route.

The map update request transmitting section 44 transmits a signal for requesting updating of the map data to the map server 10. A map update request transmitted by the map update request transmitting section 44 includes data on the first route, relevant version information, and used-route data.

The map data receiving section 46 receives map data transmitted from the map server 10. The map updating section 48 updates the map data stored in the map DB storage 32 with the map data received from the map server 10.

The configurations of the map server 10 and navigation apparatus 30 included in the map updating system 1 according to the first embodiment of the present disclosure have been described. The map server 10 and the navigation apparatus 30 can be configured by having the foregoing functions executed by a computer provided with a CPU, RAM, ROM, and I/O interfaces under program control. Such a program is also included in the scope of the present disclosure.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

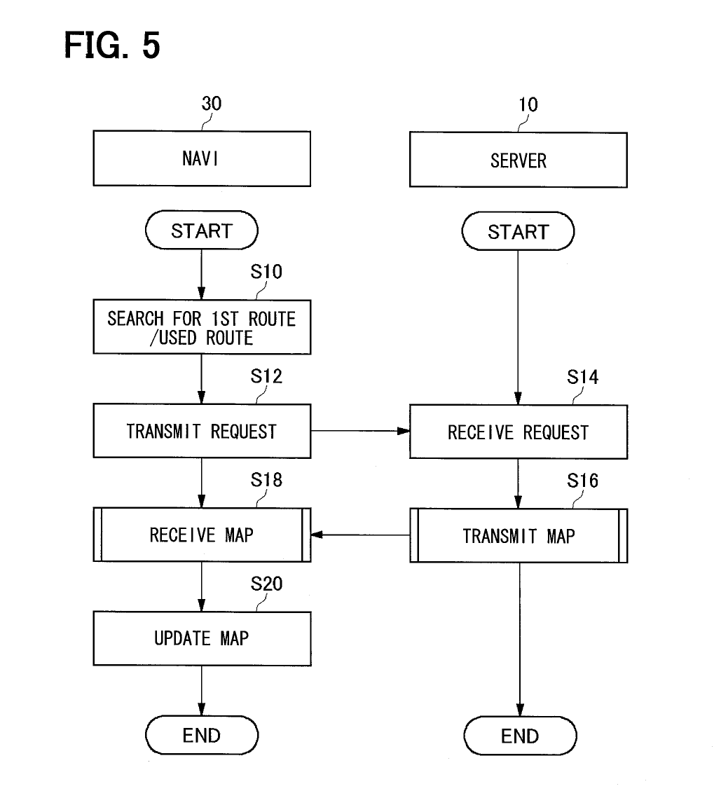

FIG. 5 shows operation of the map updating system 1 according to the first embodiment. The map updating operation is started periodically (e.g. every one month) or when a report of map updating is received from the map server 10. The navigation apparatus 30 first reads the driving history data collected in a predetermined period of time from the driving history DB storage 34 and, based on the driving history data, determines a first route and a used route (S10).

Next, the navigation apparatus 30 transmits a map update request to the map server 10 (S12). The map update request transmitted by the navigation apparatus 30 includes (i) data indicating the first route determined at S10, (ii) version information about the map data on the road links forming the first route, and (iii) data on the used route. The map server 10 receives the map update request transmitted from the navigation apparatus 30 (S14).

Responding to the map update request received from the navigation apparatus 30, the map server 10 transmits the required map data to the navigation apparatus 30 (S16). The navigation apparatus 30 receives the map data transmitted from the map server 10 (S18) and updates its map DB storage 32 with the received map data (S20).

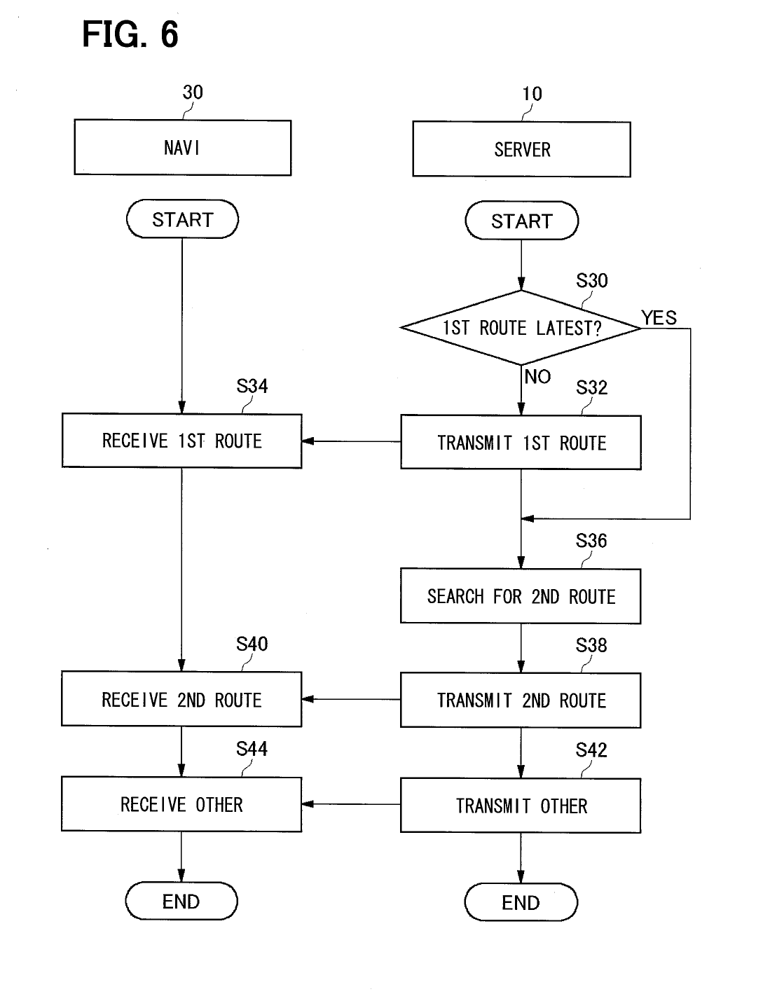

FIG. 6 shows the operation of map data transmission from the map server 10 to the navigation apparatus 30. The operation shown in FIG. 6 represents detailed contents of the operation performed at S16 and S18 shown in FIG. 5 and is started when a map update request is received from the navigation apparatus 30 (S14). The map server 10 determines whether the map data, held by the navigation apparatus 30, on the road links forming the first route is of the latest version (S30). This is done by comparing (i) the version information, included in the map update request, about the map data on the road links forming the first route and (ii) the version information about the map data on the corresponding road links represented on the latest-version map. To be specific, with the first route formed of a plurality of road links, the map server 10 compares the version information about the map data on each of the road links. When, as a result, the map data on the road links forming the first route is determined to be entirely of the latest version (S30=YES), the map data on the first route need not be updated. In this case, processing advances to searching for a second route (S36).

When the map data on the road links forming the first route is determined not to be of the latest version (S30=NO), the map server 10 transmits the latest-version map data on such road links to the navigation apparatus 30 (S32). The navigation apparatus 30 receives the map data transmitted from the map server 10 (S34).

Next, the map server 10 searches for a second route to be used when a part of the first route cannot be used (S36). To be specific, the map server 10 searches for a route leading from the starting location, from which the user previously went to the first destination, to the first destination. When, as a result, a route different from the first route is found, the map server 10 determines the different route as a second route. Alternatively, the map server 10 determines a second route based on the first route and the used-route data. This is done by searching for a route that has (i) the location, where a used route branches from the first route, specified as a starting location and (ii) the location, where the used route rejoins the first route, specified as a destination.

The map server 10 transmits the map data on the road links forming the second route to the navigation apparatus 30 (S38), whereas the navigation apparatus 30 receives the map data (S40). Subsequently, the map server 10 transmits map data on other road links to the navigation apparatus 30 (S42), and the navigation apparatus 30 receives the map data (S44). The “other road links” above refers to road links other than those forming the first and second routes. The order in which the map data on other road links is transmitted may be determined appropriately. For example, the map data on other road links may be transmitted in the order of road links' closeness to the user's home or in the order of road links' closeness to the first route.

The configuration and operation of the map updating system 1 according to the first embodiment of the present disclosure has been described. According to the present embodiment, based on the concept of a first route representing a route preferentially used by the user when driving to a first destination, a second route is searched for as an alternative route which can be used when the first route cannot be used. Thus, a route really required by the user can be appropriately determined based on the user's behavior pattern that cannot be grasped based merely on the numbers of times road links were previously passed by the user. The map updating system 1 updates the map data on the first route and second route on a priority basis; this signifies that map data portions required by the user can be efficiently updated. For example, even when map updating is terminated before completion because of network congestion or because of any condition occurring on the navigation apparatus 30 side making data reception unperformable, the navigation apparatus 30 can continue normal route guidance.

In the above embodiment, the map data on the road links forming the first route is updated first, then the map data on the road links forming the second route is updated. This may be changed so as to cause the map data on the road links forming the second route to be updated first and the map data on the road links forming the first route to be updated next. The second route is not usually used by the user. Therefore, when the first route cannot be used, it is important to appropriately guide the user through the second route not to cause the user to get lost. Updating the map data on the road links forming the second route before the map data on the road links forming the first route signifies that the former is updated to the latest condition first of all. This facilitates appropriately guiding the user even when the first route becomes unusable.

Even though, in the above embodiment, the map server 10 searches for the second route, the second route may be searched for by the navigation apparatus 30.

Also, in the above embodiment, the navigation apparatus 30 transmits (i) the data indicating the first route, and (ii) the version information about the map data on the road links forming the first route, to the map server 10 thereby informing the map server 10 of the version of the map data held by the navigation apparatus 30. Alternatively, the version information about the map data held by the navigation apparatus 30 may be managed at the map server 10. In such a case, the navigation apparatus 30 need not include the version information in a map update request to be transmitted to the map server 10 or it may even become unnecessary for the navigation apparatus 30 to manage the version information.

### Second Embodiment

The configuration of a map updating system according to a second embodiment of the present disclosure will be described below. The map updating system of the second embodiment has a configuration basically the same as that of the map updating system of the first embodiment, but the former differs from the latter in the manner in which a second route is determined. In the second embodiment, the map updating system applies a previously used route determined based on driving history data as a second route.

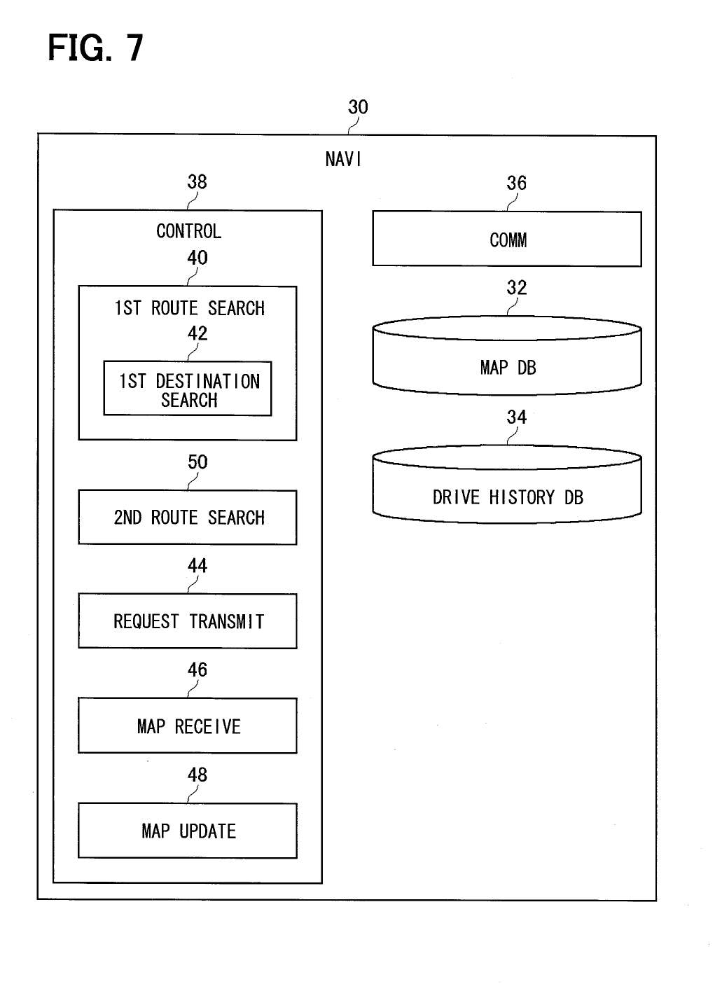

FIG. 7 shows the configuration of the navigation apparatus 30 of the second embodiment. In the navigation apparatus 30 of the second embodiment, the control circuit 38 includes a second route searching section 50. The second route searching section 50 searches for a route which was previously used to go to a first destination searched by the first route searching section 40 and which differs from the first route; the second route searching section 50 determines such a route as a second route. The map update request transmitting section 44 includes (i) data indicating the first route, (ii) data indicating the second route, and (iii) the version information about the map data on the road links forming the first route and second route, in a map update request to be transmitted.

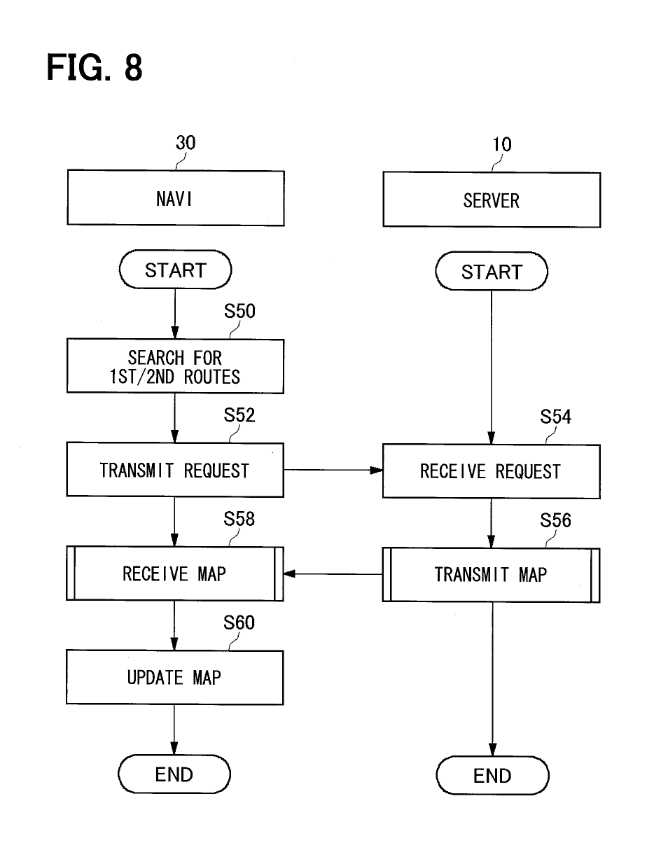

FIG. 8 shows operation of the map updating system according to the second embodiment. The map updating operation is started periodically or when a report of map updating is received from the map server 10. The navigation apparatus 30 first reads the driving history data collected in a predetermined period of time from the driving history DB storage 34 and, based on the driving history data, determines a first route and a second route (S50).

Next, the navigation apparatus 30 transmits a map update request to the map server 10 (S52). The map update request transmitted by the navigation apparatus 30 includes data indicating the first route and data indicating the second route, which were determined at S50, and the version information about the map data on the road links forming the first route and second route. The map server 10 receives the map update request transmitted from the navigation apparatus 30 (S54).

Responding to the map update request received from the navigation apparatus 30, the map server 10 transmits the required map data to the navigation apparatus 30 (S56). The navigation apparatus 30 receives the map data transmitted from the map server 10 (S58) and updates its map DB storage 32 with the received map data (S60).

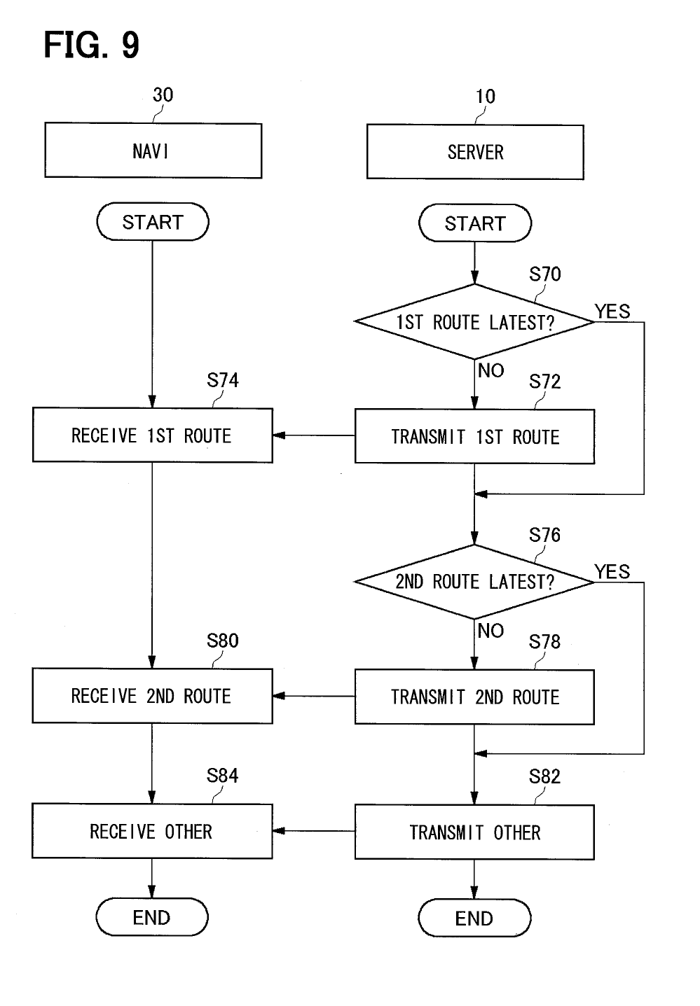

FIG. 9 shows the operation of map data transmission from the map server 10 to the navigation apparatus 30. The operation shown in FIG. 9 represents detailed contents of the operation performed at S56 and S58 shown in FIG. 8 and is started when a map update request is received from the navigation apparatus 30 (S54). The map server 10 determines whether the map data, held by the navigation apparatus 30, on the road links forming the first route is of the latest version (S70). This is done by comparing (i) the version information, included in the map update request, about the map data on the road links forming the first route and (ii) the version information about the map data on the corresponding road links represented on the latest-version map. When, as a result, the map data on the road links forming the first route is determined to be entirely of the latest version (S70=YES), the map data on the first route need not be updated. In this case, processing advances to searching for a second route (S76 onward).

When the map data on the road links forming the first route is determined not to be of the latest version (S70=NO), the map server 10 transmits the latest-version map data on such road links to the navigation apparatus 30 (S72). The navigation apparatus 30 receives the map data transmitted from the map server 10 (S74).

Next, the map server 10 determines whether the map data, held by the navigation apparatus 30, on the road links forming the second route is of the latest version (S76). This is done by comparing (i) the version information, included in the map update request, about the map data on the road links forming the second route and (ii) the version information about the map data on the corresponding road links represented on the latest-version map. When, as a result, the map data on the road links forming the second route is determined to be entirely of the latest version (S76=YES), the map data on the second route need not be updated. In this case, processing advances to transmission of other map data (S82).

When the map data on the road links forming the second route is determined not to be of the latest version (S76=NO), the map server 10 transmits the latest-version map data on such road links to the navigation apparatus 30 (S78). The navigation apparatus 30 receives the map data transmitted from the map server 10 (S80). Subsequently, the map server 10 transmits map data on other road links to the navigation apparatus 30 (S82), and the navigation apparatus 30 receives the map data transmitted from the map server 10 (S84).

The configuration and operation of the map updating system according to the second embodiment of the present disclosure has been described. In the map updating system of the second embodiment, like in the map updating system of the first embodiment, map data portions required by the user can be updated on a priority basis so as to enable the navigation apparatus 30 to provide route guidance suitably.

Also, in the second embodiment, a second route is determined by the navigation apparatus 30, so that the processing burden on the map server 10 is reduced.

### Third Embodiment

A map updating system according to a third embodiment of the present disclosure will be described below. Whereas, in the map updating systems of the first and second embodiments, the map data is updated on a road link basis, in the map updating system of the third embodiment, the map data is updated on an area basis. Namely, the map server 10 divides a map into a plurality of areas and manages the version information about the map data on each of the areas. When the version information about the map data on an area for which a map data update request has been received does not indicate the latest version, the map server 10 transmits the latest-version map data on the area to the navigation apparatus 30.

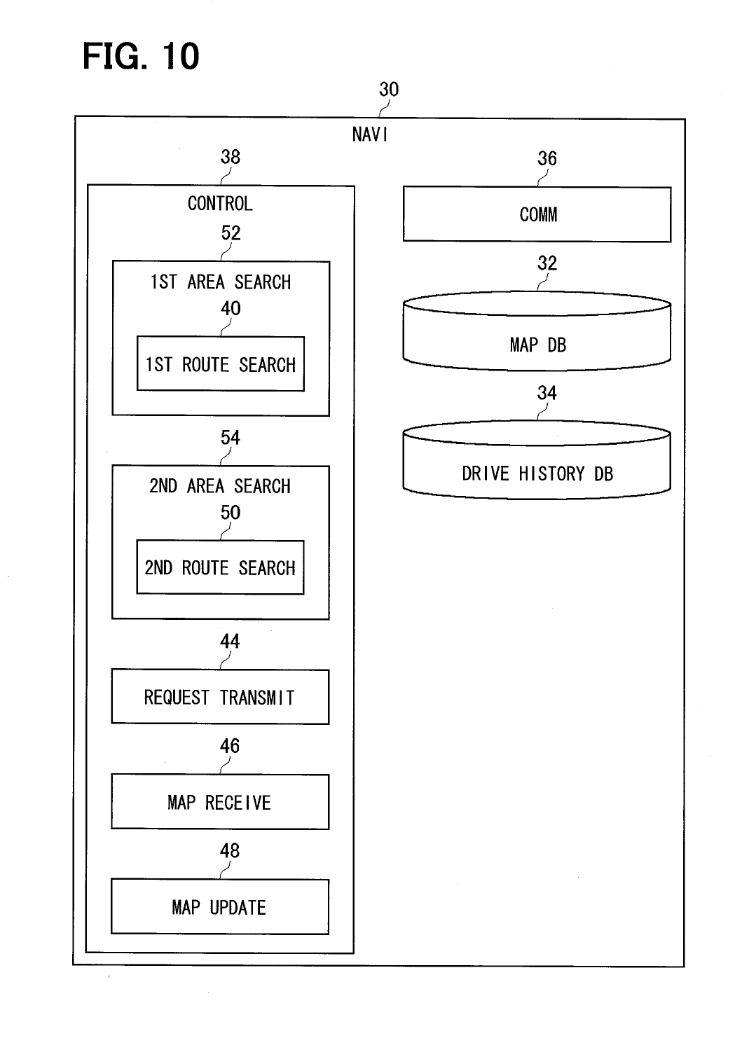

FIG. 10 shows the configuration of the navigation apparatus 30 according to the third embodiment of the present disclosure. The navigation apparatus 30 of the third embodiment has a configuration basically the same as that of the navigation apparatus 30 of the first embodiment, but, between the third and first embodiments, the control circuit 38 differs in function. The control circuit 38 of the navigation apparatus 30 of the third embodiment includes a first area searching section 52, a second area searching section 54, a map update request transmitting section 44, a map data receiving section 46, and a map updating section 48.

The first area searching section 52 includes a first route searching section 40 which searches for an area (a first area) including a first route. The first route searching section 40 performs processing as described in connection with the first embodiment. The second area searching section 54 includes a second route searching section 50 which searches for an area (a second area) including a second route. The second route searching section 50 determines, as described in connection with the second embodiment, a used route as a second route. The second route searching section 50 may determine a second route by route searching as done by the map server 10 of the first embodiment.

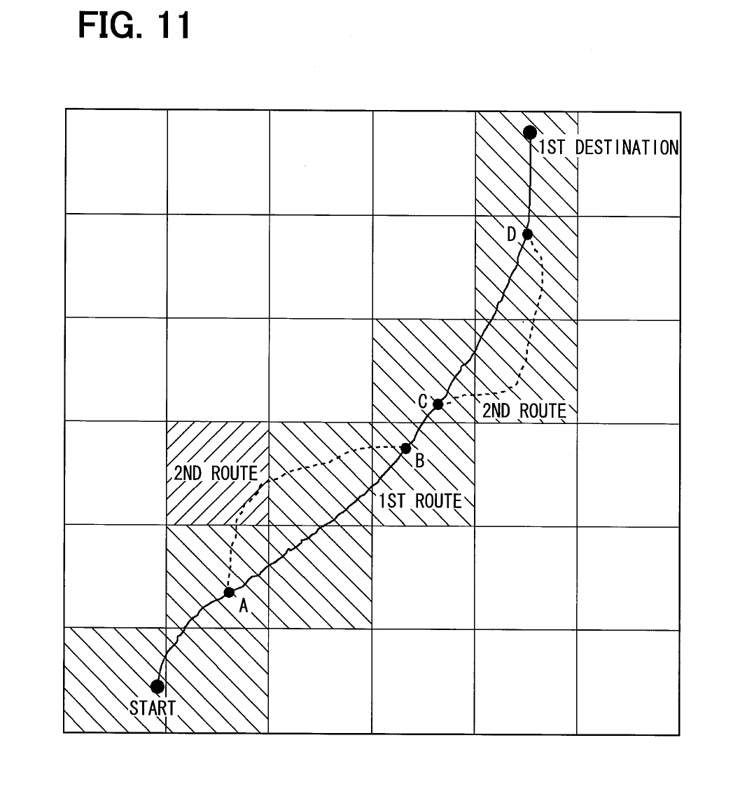

FIG. 11 shows relationships between a first route and first areas and between a second route and a second area. Referring to FIG. 11, the map is divided into a plurality of areas, and the areas including the first route are referred to as first areas whereas the area including the second route but not including the first route is referred to as a second area.

The map update request transmitting section 44 transmits a map update request to the map server 10. The map update request includes (i) data indicating the first areas, (ii) data indicating the second areas, and (iii) the version information about the map data on the first areas and the second areas. The map data receiving section 46 receives the map data transmitted from the map server 10. The map updating section 48 updates the map data stored in the map DB storage 32 with the map data received from the map server 10.

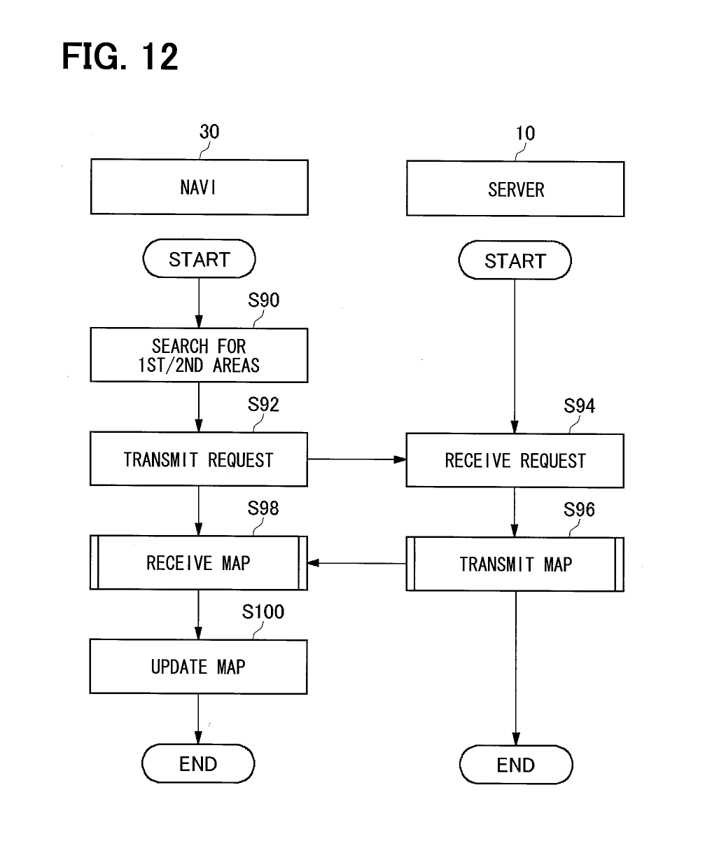

FIG. 12 shows operation of the map updating system according to the third embodiment. The map updating operation is started periodically or when a report of map updating is received from the map server 10. The navigation apparatus 30 first reads the driving history data collected in a predetermined period of time from the driving history DB storage 34 and, based on the driving history data, determines first areas and second areas (S90).

Next, the navigation apparatus 30 transmits a map update request to the map server 10 (S92). The map update request transmitted by the navigation apparatus 30 includes (i) the data indicating the first areas determined at S90, (ii) the data indicating the second areas determined at S90, and (iii) the version information about the map data on the first areas and the second areas. The map server 10 receives the map update request transmitted from the navigation apparatus 30 (S94).

Responding to the map update request received from the navigation apparatus 30, the map server 10 transmits the required map data to the navigation apparatus 30 (S96). The navigation apparatus 30 receives the map data transmitted from the map server 10 (S98) and updates the map data stored in the map DB storage 32 with the received map data (S100).

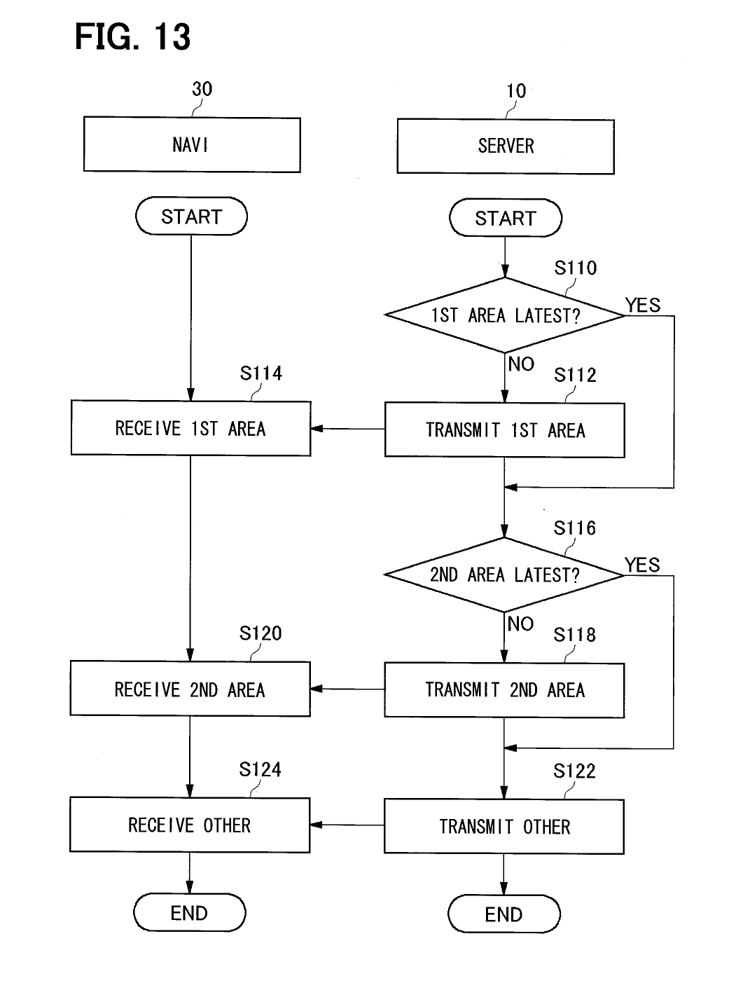

FIG. 13 shows the operation of map data transmission from the map server 10 to the navigation apparatus 30. The operation shown in FIG. 13 represents detailed contents of the operation performed at S96 and S98 shown in FIG. 12 and is started when a map update request is received from the navigation apparatus 30 (S94). The map server 10 determines whether the map data, held by the navigation apparatus 30, on the first areas is of the latest version (S110). This is done by comparing (i) the version information, included in the map update request, about the map data on the first areas and (ii) the version information about the map data on the corresponding areas represented on the latest-version map. When, as a result, the map data on the first areas is determined to be entirely of the latest version (S110=YES), the map data on the first areas need not be updated. In this case, processing advances to updating of the map data on the second areas (S116 onward).

When the map data on the first areas is determined not to be of the latest version (S110=NO), the map server 10 transmits the map data on the first areas to the navigation apparatus 30 (S112). The navigation apparatus 30 receives the map data transmitted from the map server 10 (S114).

Next, the map server 10 determines whether the map data, held by the navigation apparatus 30, on the second areas is of the latest version (S116). This is done by comparing (i) the version information, included in the map update request, about the map data on the second areas and (ii) the version information about the map data on the corresponding areas represented on the latest-version map. When, as a result, the map data on the second areas is determined to be entirely of the latest version (S116=YES), the map data on the second areas need not be updated. In this case, processing advances to transmission of map data on other areas (S122).

When the map data on the second areas is determined not to be of the latest version (S116=NO), the map server 10 transmits the map data on the second areas to the navigation apparatus 30 (S118). The navigation apparatus 30 receives the map data transmitted from the map server 10 (S120). Subsequently, the map server 10 transmits map data on other areas (i.e., areas other than the first areas or the second areas) to the navigation apparatus 30 (S122), and the navigation apparatus 30 receives the map data transmitted from the map server 10 (S124).

The configuration and operation of the map updating system according to the third embodiment of the present disclosure has been described. In the map updating system of the third embodiment, like in the map updating system of the first embodiment, map data portions required by the user can be updated on a priority basis so as to enable the navigation apparatus 30 to provide route guidance suitably. Also, in the third embodiment, the map is updated on an area basis. This makes map version management easy compared with cases where the map is updated on a road link basis.

According to the above embodiment, the map data on the first areas is updated first, then the map data on the second areas is updated. This may be changed so as to cause the map data on the second areas to be updated first and the map data on the first areas to be updated next. Updating the map data on the second areas including the second route before the map data on the first areas including the first route increases the possibility of being able to appropriately guide the user even when the first route becomes unusable.

It is noted that, in the present embodiment, the navigation apparatus 30 may hold map data of an earlier version; however, this is good enough as long as the navigation apparatus 230 can find the areas including the second route. Further, even though, in the above embodiment, the navigation apparatus 30 searches for the second areas, the second areas may be searched for by the map server 10.

### Fourth Embodiment

A map updating system according to a fourth embodiment of the present disclosure will be described below. The map updating system of the fourth embodiment has a configuration basically the same as that of the map updating system of the third embodiment. However, the fourth embodiment determines areas adjoining any first area as second areas unlike the third embodiment that searches for second areas based on a second route.

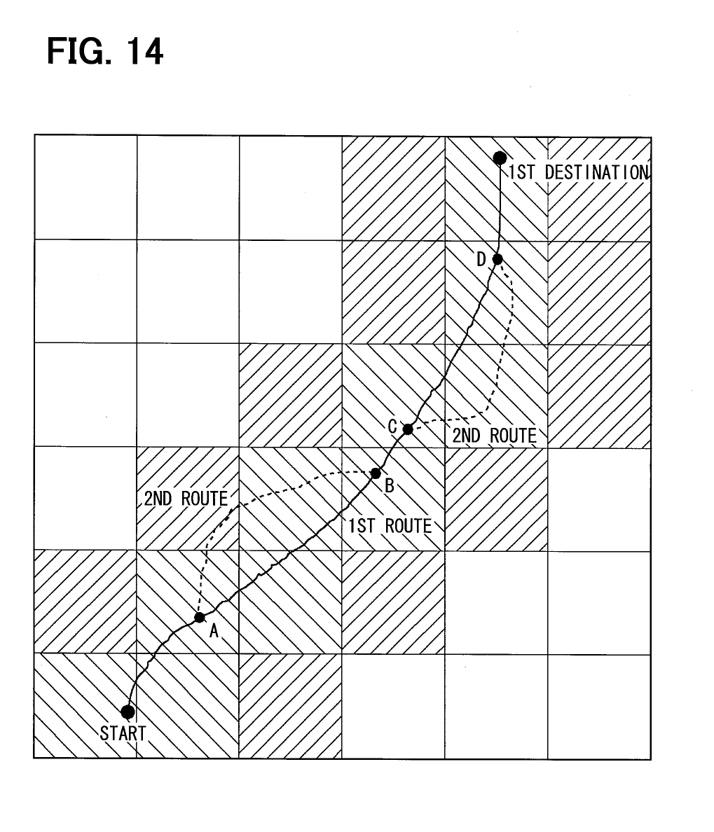

FIG. 14 shows an example of determining first areas and second areas based on a first route. In the present embodiment, like in the third embodiment, areas including a first route are determined as first areas. Then, in the present embodiment, the second area searching section 54 determines all areas adjoining any of the first areas as second areas. The second areas determined in this manner may include, as shown in FIG. 14, both areas including the second route and areas not including the second route. In the present embodiment, the map is updated using the first areas and second areas like in the third embodiment.

In the fourth embodiment, all areas adjoining any of the first areas are determined as second areas; namely, the second areas can be determined easily.

### Fifth Embodiment

A map updating system according to a fifth embodiment of the present disclosure will be described below. The map updating system of the fifth embodiment performs map updating, using the same configuration as that of the map updating system of the first embodiment and taking into consideration a route (a third route) previously used to go to an infrequently visited destination (a second destination).

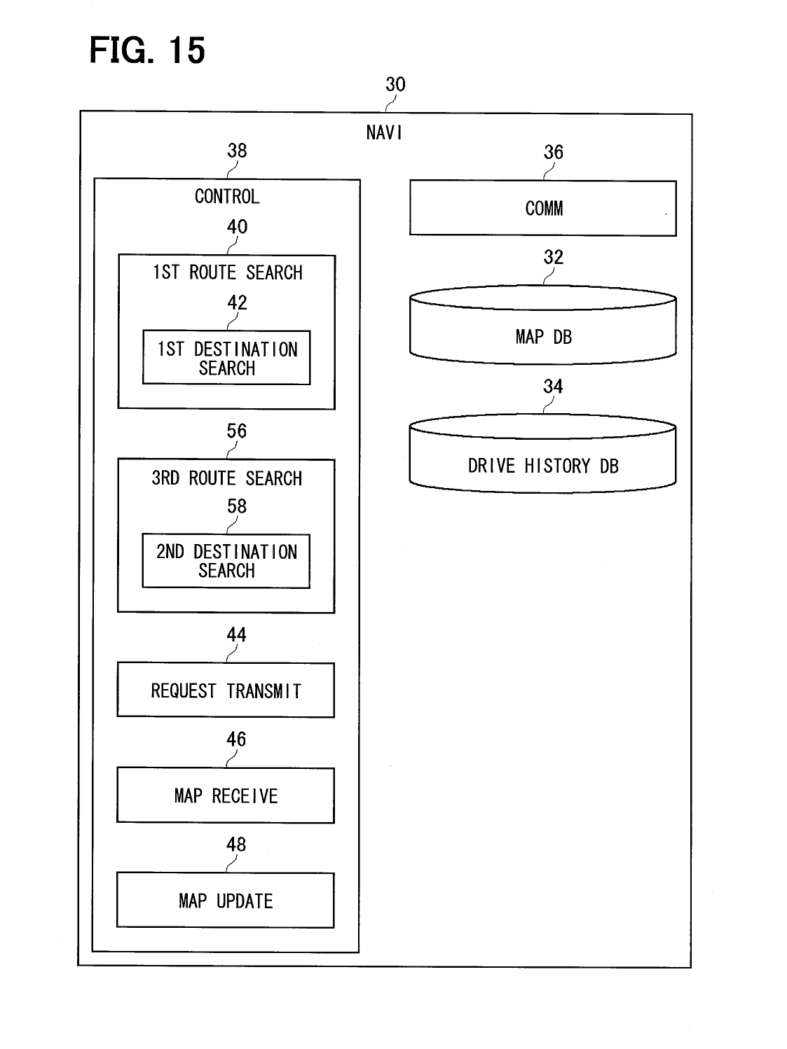

FIG. 15 shows the configuration of the navigation apparatus 30 according to the fifth embodiment of the present disclosure. The control circuit 38 included in the navigation apparatus 30 of the fifth embodiment having the functions of the control circuit 38 of the navigation apparatus 30 of the first embodiment is additionally provided with a third route searching section 56. The third route searching section 56 includes a second destination searching section 58. The second destination searching section 58 searches, based on the data stored in the driving history DB storage 34, for a location (a second destination) which was visited less than a predetermined number of times (e.g. three times) during a predetermined period of time (e.g. the last three months). The third route searching section 56 then searches for the most used one of the routes used to go to the second destination and determines the most used route as a third route. The third route thus determined is a route used by the user when going to an infrequently visited destination. Namely, the requirement to update the map data on the third route is higher than for the map data on other routes not used at all.

While searching for the third route, the third route searching section 56 also searches for other routes previously used to go to the second destination. Such previously used routes are referred to as “used routes.”

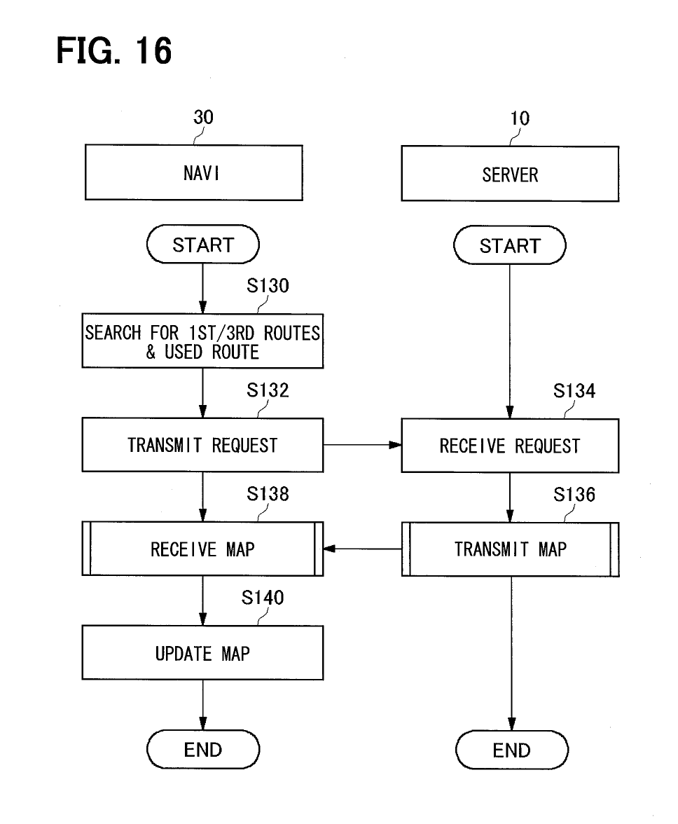

FIG. 16 shows operation of the map updating system according to the fifth embodiment. The map updating operation is started periodically (e.g. every one month) or when a report of map updating is received from the map server 10. The navigation apparatus 30 first reads the driving history data collected in a predetermined period of time from the driving history DB storage 34 and, based on the driving history data, determines a first route, a third route, and previously used routes corresponding to them (S130).

Next, the navigation apparatus 30 transmits a map update request to the map server 10 (S132). The map update request transmitted by the navigation apparatus 30 includes (i) the data indicating the first route determined at S130, (ii) the data indicating the third route determined at S130, and (iii) the version information about the map data on the road links forming the first route and the third route, and data on used routes corresponding to the first route or third route. The map server 10 receives the map update request transmitted from the navigation apparatus 30 (S134).

Responding to the map update request received from the navigation apparatus 30, the map server 10 transmits the required map data to the navigation apparatus 30 (S136). The navigation apparatus 30 receives the map data transmitted from the map server 10 (S138) and updates the map data in the map DB storage 32 with the received map data (S140).

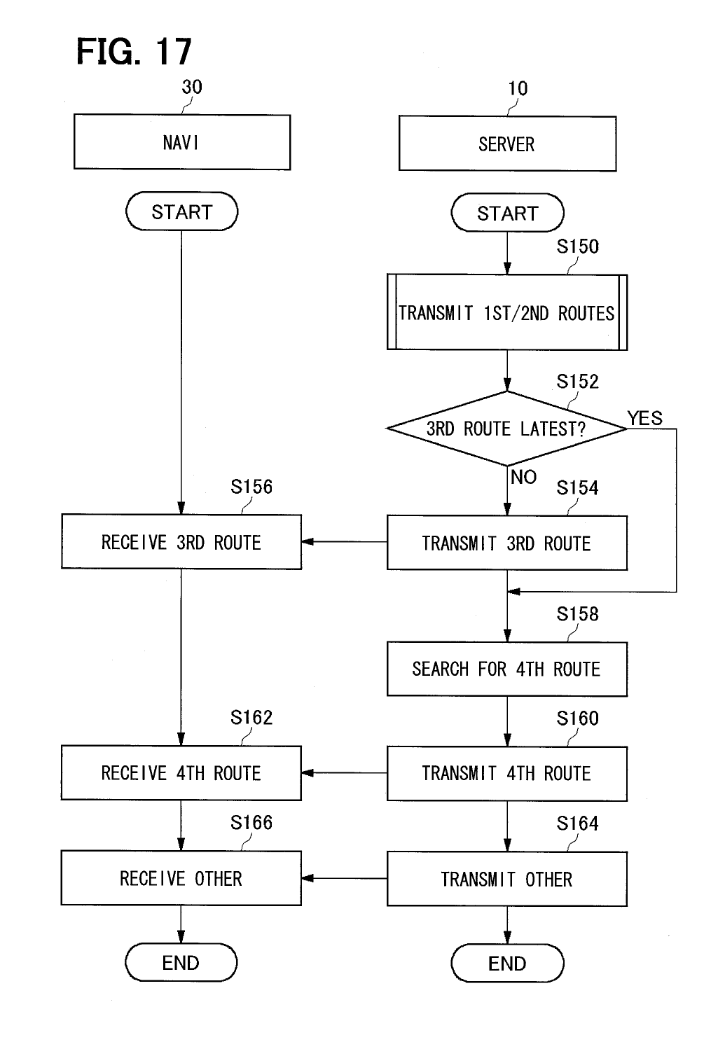

FIG. 17 shows the operation of map data transmission from the map server 10 to the navigation apparatus 30. The operation shown in FIG. 17 represents detailed contents of the operation performed at S136 and S138 shown in FIG. 16 and is started when a map update request is received from the navigation apparatus 30 (S134). The processing performed to update the data on the road links forming the first route and second route is the same as described in connection with the first embodiment (S150: See S30 to S40 in FIG. 6).

The map server 10 determines whether the map data, held by the navigation apparatus 30, on the third route is of the latest version (S152). This is done by comparing (i) the version information, included in the map update request, about the map data on the road links forming the third route and (ii) the version information about the map data on the corresponding road links represented on the latest-version map. When, as a result, the map data on the road links forming the third route is determined to be entirely of the latest version (S152=YES), the map data on the third route need not be updated. In this case, processing advances to searching for a fourth route (S158).

When the map data on the road links forming the third route is determined not to be of the latest version (S152=NO), the map server 10 transmits the latest-version map data on the road links forming the third route to the navigation apparatus 30 (S154). The navigation apparatus 30 receives the map data transmitted from the map server 10 (S156).

Next, the map server 10 searches for a fourth route to be used when a part of the third route cannot be used (S158). To be specific, the map server 10 searches for a route leading from the starting location, from which the user previously went to the second destination, to the second destination. When, as a result, a route different from the third route is found, the map server 10 determines the different route as a fourth route. Alternatively, the map server 10 determines a fourth route based on the third route and the used-route data. This is done by searching for a route with (i) the location where a used route branches from the third route specified as a starting location and (ii) the location where the used route rejoins the third route specified as a destination.

The map server 10 transmits the map data on the road links forming the fourth route to the navigation apparatus 30 (S160), whereas the navigation apparatus 30 receives the map data (S162). Subsequently, the map server 10 transmits map data on other road links to the navigation apparatus 30 (S164), and the navigation apparatus 30 receives the map data (S166). The “other road links” above refers to road links other than those forming the first route, the second route, the third route and the fourth route.

The configuration and operation of the map updating system according to the fifth embodiment of the present disclosure has been described. According to the fifth embodiment, following updating of the map data on the road links forming the first route and second route, the map data on the road links forming the third route and fourth route to a second destination infrequently visited by the user is updated. Thus, the map can be updated in the order of user's requirement.

Even though, in the above embodiment, the map server 10 searches for a fourth route, the fourth route may be searched for by the navigation apparatus 30. Also, instead of determining a fourth route by route searching, a route previously used to go to the second destination may be determined, as it is, as a fourth route.

A fourth route may be searched for in a different manner than described above. For example, a different facility of the same attribute as that of the second destination may be found from around the second destination and a route leading to the different facility may be determined as a fourth route. The different facility of the same attribute as that of the second destination is, for example, a shop belonging to the same business affiliation as the second destination or a shop in the same trade as the second destination.

### Sixth Embodiment

A map updating system according to a sixth embodiment of the present disclosure will be described below. The map updating system of the sixth embodiment performs map updating, using the same configuration as that of the map updating system of the third embodiment and taking into consideration a route (a third route) previously used to go to an infrequently visited destination (a second destination).

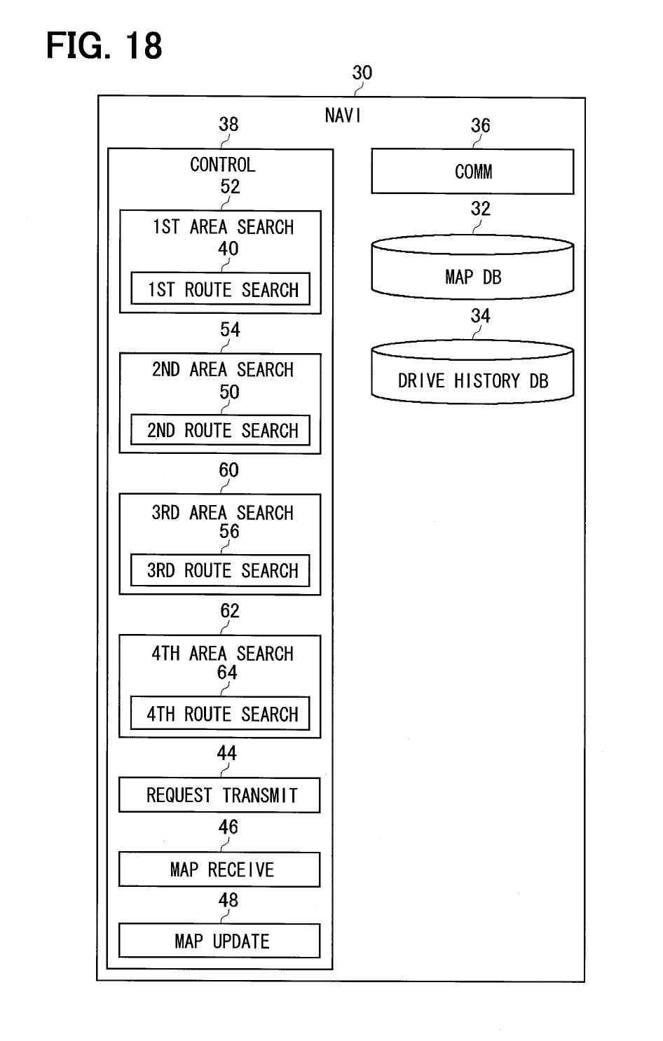

FIG. 18 shows the configuration of the navigation apparatus 30 according to the sixth embodiment of the present disclosure. The control circuit 38 included in the navigation apparatus 30 of the sixth embodiment having the functions of the control circuit 38 of the navigation apparatus 30 of the third embodiment is additionally provided with a third area searching section 60 and a fourth area searching section 62. The third area searching section 60 searches, based on the data stored in the driving history DB storage 34, for a location (a second destination) which was visited less than a predetermined number of times (e.g. three times) during a predetermined period of time (e.g. the last three months). The third area searching section 60 then searches for the most used one of the routes used to go to the second destination and determines the most used route as a third route. The third area searching section 60 determines the areas including the third route as the third areas.

The fourth area searching section 62 includes a fourth route searching section 64. The fourth route searching section 64 determines a route, other than the third route, previously used to go to the second destination searched for by the third area searching section 60 as a fourth route. The fourth area searching section 62 determines the areas including the fourth route as the fourth areas.

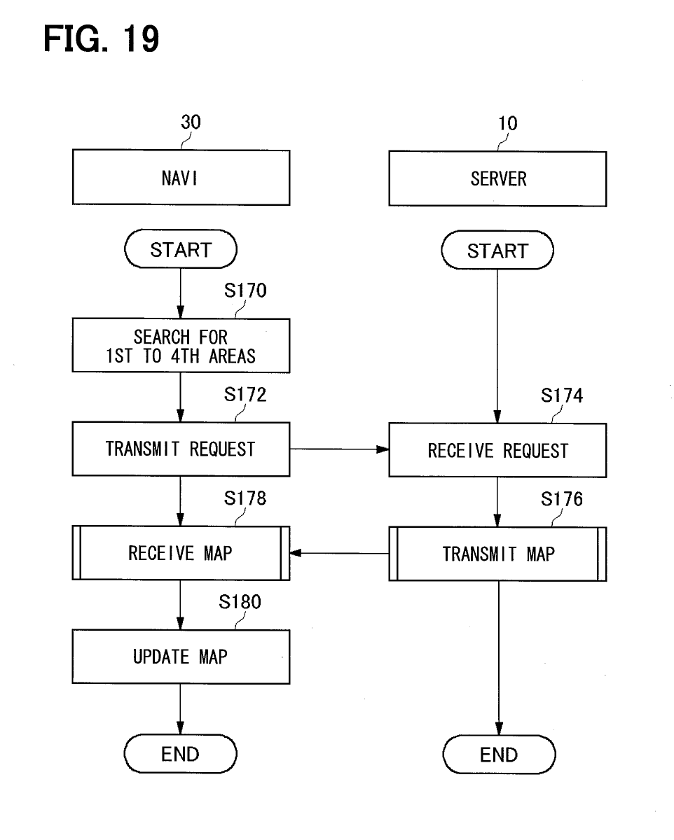

FIG. 19 shows operation of the map updating system according to the sixth embodiment. The map updating operation is started periodically (e.g. every one month) or when a report of map updating is received from the map server 10. The navigation apparatus 30 first reads the driving history data collected in a predetermined period of time from the driving history DB storage 34 and, based on the driving history data, determines first to fourth areas (S170).

Next, the navigation apparatus 30 transmits a map update request to the map server 10 (S172). The map update request transmitted by the navigation apparatus 30 includes the data indicating the first to fourth areas determined at S170 and the version information about the map data on the first to fourth areas. The map server 10 receives the map update request transmitted from the navigation apparatus 30 (S174).

Responding to the map update request received from the navigation apparatus 30, the map server 10 transmits the required map data to the navigation apparatus 30 (S176). The navigation apparatus 30 receives the map data transmitted from the map server 10 (S178) and updates the map data in the map DB storage 32 with the received map data (S180).

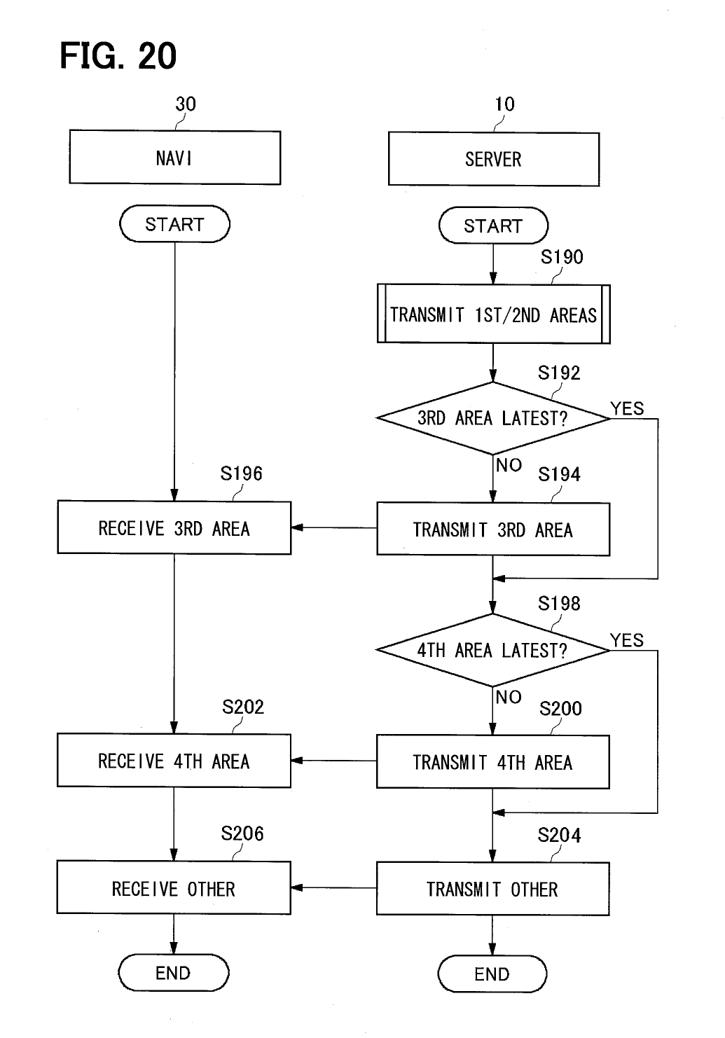

FIG. 20 shows the operation of map data transmission from the map server 10 to the navigation apparatus 30. The operation shown in FIG. 20 represents detailed contents of the operation performed at S176 and S178 shown in FIG. 19 and is started when a map update request is received from the navigation apparatus 30 (S174). The processing performed to update the data on the first and second areas is the same as described in connection with the third embodiment (S190: See S110 to S120 in FIG. 13).

The map server 10 determines whether the map data, held by the navigation apparatus 30, on the third areas is of the latest version (S192). This is done by comparing (i) the version information, included in the map update request, about the map data on the third areas and (ii) the version information about the map data on the corresponding areas represented on the latest-version map. When, as a result, the map data on the third areas is determined to be entirely of the latest version (S192=YES), the map data on the third areas need not be updated. In this case, processing advances to updating of the map data on the fourth areas (S198).

When the map data on the third areas is determined not to be of the latest version (S192=NO), the map server 10 transmits the latest-version map data on the third areas to the navigation apparatus 30 (S194). The navigation apparatus 30 receives the map data transmitted from the map server 10 (S196).

Next, the map server 10 determines whether the map data, held by the navigation apparatus 30, on the fourth areas is of the latest version (S198). This is done by comparing (i) the version information, included in the map update request, about the map data on the fourth areas and (ii) the version information about the map data on the corresponding areas represented on the latest-version map. When, as a result, the map data on the fourth areas is determined to be entirely of the latest version (S198=YES), the map data on the fourth areas need not be updated. In this case, processing advances to transmission of other map data (S204).

When the map data on the fourth areas is determined not to be of the latest version (S198=NO), the map server 10 transmits the latest-version map data on the fourth areas to the navigation apparatus 30 (S200). The navigation apparatus 30 receives the map data transmitted from the map server 10 (S202). Subsequently, the map server 10 transmits map data on other areas than the first to fourth areas to the navigation apparatus 30 (S204), whereas the navigation apparatus 30 receives the map data (S206).

The configuration and operation of the map updating system according to the sixth embodiment of the present disclosure has been described. According to the sixth embodiment, following updating of the map data on the first and second areas, the map data on the third and fourth areas including the third and fourth routes to the second destination infrequently visited by the user is updated. Thus, the map can be updated in the order of user's requirement.

Even though, in the above embodiment, areas including the fourth route previously used to go to the second destination are searched for and are determined as the fourth areas, areas adjoining any of the third areas may be determined as the fourth areas.

Even though, in the above embodiment, out of a plurality of routes leading to a frequently visited destination, a first route is determined, a route leading from the starting location to a frequently visited location (e.g. a transit location or a branching location) may be determined as a first route. There are cases in which a first route is partly overlapped with a route to an infrequently visited destination.

Further, assume, for example, a case where there are three second destinations not so frequently visited, say, each visited once or twice so far, and the routes (third routes) to the three second destinations have a common segment, i.e. a portion overlapping among the third routes. In the map updating system according to the present disclosure, when the number of times the overlapping portion of the third routes was used either equals or exceeds a predetermined number of times (e.g. five times), the overlapping portion may be treated as a first route, and the map data on the first route and an alternative route which may be used instead of the first route may be updated on a priority basis. In this way, the user can update the map according to necessity. Even though in the present example, whether to treat the overlapping portion as a first route is determined based on a threshold of the number of times the overlapping portion was used, a predetermined frequency at which the overlapping portion was used may be applied as a threshold.

The present disclosure has an advantageous effect that map data required by a user can be effectively updated, so that the present disclosure can be usefully applied to navigation apparatuses having map data.

While aspects of the disclosure described herein are already recited in the preceding summary, further optional aspects thereto may be set out as follows.

In the map updating system according to an optional aspect of the present disclosure, the second route searching section may determine the second route by: (1) searching for a route leading from the predetermined location to the first destination; (2) searching, based on the driving history data, for a route which is other than the first route and which was used to go to the first destination from the predetermined location; and (3) searching, based on the driving history data, for a route with (i) a location where a route used to go to the first destination from the predetermined location branches from the first route specified as a starting location and (ii) a location where the route having branched from the first route rejoins the first route specified as a destination. In this way, a second route can be appropriately determined.

In the map updating system according to an optional aspect of the present disclosure, the first destination determining section may determine a location which was, during a predetermined last period of time, visited a predetermined number of times or more or visited at a predetermined frequency or more as a first destination. In this way, a first destination reflecting a recently used route can be determined.

In the map updating system according to an optional aspect of the present disclosure, the second route searching section may be included in the map server. Route searching by the map server having the latest map data makes it possible to appropriately determine a second route even when a new road is opened or an existing road is changed.

In the map updating system according to an optional aspect of the present disclosure, the map updating section may update data on the first route before data on the second route. In this way, a frequently used route can be updated on a priority basis.

In the map updating system according to an optional aspect of the present disclosure, the map updating section may update data on the second route before data on the first route. In this way, an alternative route to be used when a part of a frequently used route cannot be used can be updated on a priority basis. Whereas the user is familiar with a frequently used route and can drive such a frequently used route without the latest map, the user will require a correct map when driving an alternative route which is not usually used. Updating such an alternative route on a priority basis will meet the user's needs.

In the map updating system according to an optional aspect of the present disclosure, the map data held by the map server is divided into multiple areas, and the map updating section may update the map data in order of (i) data on a first area including the first route and a second area including the second route, and (ii) data on other areas.

In this way, the map can be updated on an area basis so as to update the map data on areas required by the user on a priority basis.

In the map updating system according to an optional aspect of the present disclosure, the map data held by the map server is divided into multiple areas, and the map updating section may update the map data in order of (i) data on a first area including the first route and a second area adjoining the first area, and (ii) data on other areas. In this way, a second area including a route which can be used when the first route cannot be used can be easily determined.

In the map updating system according to an optional aspect of the present disclosure, the map updating section may update data on the first area before data on the second area. In this way, an area including a frequently used route can be updated on a priority basis.

In the map updating system according to an optional aspect of the present disclosure, the map updating section may update data on the second area before data on the first area. In this way, an area including an alternative route which can be used when a part of a frequently used route cannot be used can be updated on a priority basis.

The map updating system according to an optional aspect of the present disclosure may further include a second destination determining section and a third route searching section. The second destination determining section determines, based on the driving history data, a location which was visited from the predetermined location less than a predetermined number of times or at less than a predetermined frequency as a second destination. The third route searching section determines, based on the driving history data, a route used to visit the second destination from the predetermined location as a third route. The map updating section may update the map data in order of (i) data on the first route and second route, (ii) data on the third route, and (iii) other data. In this way, the map data on a route to an infrequently visited second destination can be updated following updating of the map data on the first and second routes. Namely, the map data can be efficiently updated in order of the necessity by the user.

The map updating system according to an optional aspect of the present disclosure may further include a fourth route searching section which determines a fourth route to be used, when a part of the third route cannot be used, to visit the second destination from the predetermined location. The map updating section may update the map data in order of (i) data on the first route and second route, (ii) data on the third route, and (iii) data on the fourth route. In this way, the map data on an alternative route to be used instead of the third route to the infrequently visited second destination can be updated following updating of the map data on the third route. Namely, the map data can be efficiently updated in order of the necessity by the user.

In the map updating system according to an optional aspect of the present disclosure, when there are a plurality of third routes partly overlapping with one another, the first route searching section may determine whether or not the number of times the overlapping portion is used or the frequency at which the overlapping portion is used either equals or exceeds a predetermined value and, when the predetermined value is determined to have been reached or exceeded, may determine the overlapping portion as a first route. When a plurality of routes to a second destination share an overlapping portion among them, the overlapping portion may be a frequently used route. According to an optional aspect of the present disclosure, it is possible to update the map data on such an overlapping portion of a plurality of routes leading to an infrequently visited second destination on a priority basis.

In the map updating system according to an optional aspect of the present disclosure, the map data held by the map server is divided into a plurality of areas, and the map updating section may update the map data in order of (i) data on a first area including the first route and a second area including the second route, (ii) data on a third area including the third route, and (iii) data on other areas. In this way, the map can be updated on an area basis in order of the necessity by the user.

In the map updating system according to an optional aspect of the present disclosure, the map data held by the map server is divided into a plurality of areas, and the map updating section may update the map data in order of (i) data on a first area including the first route and a second area including the second route, (ii) data on a third area including the third route, (iii) data on a fourth area including the fourth route, and (iv) data on other areas. In this way, the map can be updated on an area basis in order of the necessity by the user.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A map updating system including a map server and a navigation apparatus mounted to a vehicle, the navigation apparatus containing map data that is updated with latest map data in the map server via a network,
the map updating system comprising:
a driving history database storage which stores driving history data on the vehicle mounted with the navigation apparatus;
a first destination determining section which determines a first destination based on the driving history data, the first destination being a location visited from a predetermined location a predetermined number of times or more or at a predetermined frequency or more;
a first route searching section which determines a first route based on the driving history data, the first route being a route that was used a predetermined number of times or more or at a predetermined frequency or more among routes having been used to visit the first destination from the predetermined location;
a second route searching section which determines a second route that is to be used to visit the first destination from the predetermined location when a part of the first route is unusable; and
a map updating section which updates the map data in the navigation apparatus in an order of (i) data on the first route and the second route, and (ii) other data.

2. The map updating system according to claim 1, wherein:
the second route searching section determines the second route by searching for a route leading from the predetermined location to the first destination.

3. The map updating system according to claim 1, wherein:
the second route searching section determines the second route by searching, based on the driving history data, for a route which is other than the first route and which was used to go to the first destination from the predetermined location.

4. The map updating system according to claim 1, wherein:
the second route searching section determines the second route by searching, based on the driving history data, for a route with (i) a start location being a branch location and (ii) a destination being a rejoin location,
the branch location at which a route used to go to the first destination from the predetermined location branches from the first route,
the rejoin location at which the route having branched from the first route rejoins the first route.

5. The map updating system according to claim 1, wherein:
the first destination determining section determines the first destination being a location which was visited a predetermined number of times or more or at a predetermined frequency or more during a predetermined last period of time.

6. The map updating system according to claim 1, wherein:
the second route searching section is included in the map server.

7. The map updating system according to claim 1, wherein:
the map updating section updates data on the first route before data on the second route.

8. The map updating system according to claim 1, wherein:
the map updating section updates data on the second route before data on the first route.

9. The map updating system according to claim 1, wherein:
the map data in the map server is divided into a plurality of areas; and
the map updating section updates the map data in an order of (i) data on a first area including the first route and a second area including the second route, and (ii) data on other areas.

10. The map updating system according to claim 1, wherein:
the map data in the map server is divided into multiple areas; and
the map updating section updates the map data in an order of (i) data on a first area including the first route and a second area adjoining the first area, and (ii) data on other areas.

11. The map updating system according to claim 9, wherein:
the map updating section updates data on the first area before data on the second area.

12. The map updating system according to claim 9, wherein:
the map updating section updates data on the second area before data on the first area.

13. The map updating system according to claim 1, further comprising:
a second destination determining section that determines a second destination based on the driving history data, the second destination being a location which was visited from the predetermined location less than the predetermined number of times or at less than the predetermined frequency; and
a third route searching section that determines a third route based on the driving history data, the third route being a route used to visit the second destination from the predetermined location,
wherein:
the map updating section updates the map data in an order of (i) data on the first route and the second route, (ii) data on the third route, and (iii) other data.

14. The map updating system according to claim 13, further comprising:
a fourth route searching section which determines a fourth route that is to be used to visit the second destination from the predetermined location when a part of the third route is unusable,
wherein:
the map updating section updates the map data in an order of (i) data on the first route and the second route, (ii) data on the third route, and (iii) data on the fourth route.

15. The map updating system according to claim 13, wherein:
when a plurality of the third routes partly overlap with one another, the first route searching section determines whether or not a number of times an overlapping portion is used or a frequency at which the overlapping portion is used either equals or exceeds a predetermined value;
when the predetermined value is determined to have been reached or exceeded, the first route searching section determines the overlapping portion as the first route.

16. The map updating system according to claim 13, wherein:
the map data in the map server is divided into a plurality of areas; and
the map updating section updates the map data in an order of (i) data on a first area including the first route and a second area including the second route, (ii) data on a third area including the third route, and (iii) data on other areas.

17. The map updating system according to claim 14, wherein:
the map data in the map server is divided into a plurality of areas, and
the map updating section may update the map data in an order of (i) data on a first area including the first route and a second area including the second route, (ii) data on a third area including the third route, (iii) data on a fourth area including the fourth route, and (iv) data on other areas.

18. A method for a map updating system including a map server and a navigation apparatus in a vehicle, the navigation apparatus containing map data that is updated with latest map data in the map server via a network,
the method comprising:
storing driving history data on the vehicle mounted with the navigation apparatus;
determining a first destination based on the driving history data, the first destination being a location visited from a predetermined location a predetermined number of times or more or at a predetermined frequency or more;
determining a first route based on the driving history data, the first route being a route that was used a predetermined number of times or more or at a predetermined frequency or more among routes having been used to visit the first destination from the predetermined location;
determining a second route that is to be used to visit the first destination from the predetermined location when a part of the first route is unusable; and
updating the map data in the navigation apparatus in an order of (i) data on the first route and the second route, and (ii) other data.

19. A program product stored in a non-transitory computer readable storage medium comprising instructions for execution by a computer, the instructions including the method according to claim 18, the method being computer-implemented.
